(19) United States
(12) Patent Application Publication
(10) Pub. No.: US 2004/0057182 A1
(43) Pub. Date: Mar. 25, 2004

(54) Method and control apparatus for controlling two hot-swapable IDE devices

(76) Inventor: Ming-Huan Yuan, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/335,525

(22) Filed: Dec. 30, 2002

(30) Foreign Application Priority Data
Sep. 20, 2002 (TW) 91121533

(51) Int. Cl. H02H 7/00

(52) U.S. Cl. 361/100

(57) ABSTRACT

A control apparatus adapted to control two hot-swappable IDE devices (51, 52) installed in one channel of a computer system includes an IDE controller a910), a first and second quick switches (41, 42), an IDE connector (20) electrically connected between the quick switches and the IDE controller, and a hot-swap controller (30) communicating with the IDE controller through the IDE connector. Power switches (61, 62) are included for connecting a power supply of the computer system to the IDE devices. The hot-swap controller controls the quick switches to turn on or turn off so that IDE bus signals are transmitted to or are blocked from being sent to the corresponding hot plugged IDE device. The hot-swap controller also turns the power switches on or off to connect or disconnect power from the power supply to an IDE device which has been hot plugged or hot unplugged.

### BACKGROUND OF THE INVENTION

1. Field of the Invention

The present invention relates to hot-swappable IDE devices, and more particularly to a method and control apparatus for controlling two hot-swappable IDE devices.

2. Related Art

With computer technology advances, today's computer systems need a large memory capacity. Nonvolatile external memory devices with a large storage capacity are used to greatly increase memory capacity of a computer system. Currently, hard disk drives (HDDs) are one of the more popular external memory devices.

An HDD comprises a storage medium, e.g. a hard disk, a read/write head, a spindle motor that rotates the storage medium, and a circuit board. The circuit board includes a connector to connect the HDD to an interface board of a computer system. The Integrated Device Electronics (IDE) interface is a default standard interface for connecting HDDs to computer systems. An HDD that conforms to the IDE standard will be referred to as an “IDE_HDD”. The IDE standard allows two IDE_HDDs to connect to a single interface board to form an IDE channel. The interface board provides two ports for connecting two HDDs respectively. When two HDDs are connected, one HDD serves as a master HDD while the other serves as a slave HDD.

A computer system can be designed as a server to provide data stored in HDDs of the server to a network structure. Once problems occur with one of these HDDs, the HDD may need to be removed and repaired. If so, it should be removed without switching off the power supply of the system; otherwise, data may be lost. Hot-swappable IDE_HDDs are designed to meet this requirement.

In present arrangements, if two hot-swappable IDE_HDDs are installed in one channel, and one of the HDDs is removed, interference between the two hot-swappable IDE_HDDs may occur during the hot-swap event, which may interrupt the operation of the server. Therefore, the normal arrangement currently used is to allow only one hot-swappable IDE_HDD to be present in one IDE channel. A second IDE_HDD in the channel would not be hot-swappable. The problem with this arrangement is that, if the hot-swappable IDE_HDD is removed from the channel, the other port provided by the channel will be idled, resulting in loss of the whole channel until another IDE_HDD is reinserted. For this reason, a method and control apparatus for controlling two hot-swappable IDE devices is desired.

### SUMMARY OF THE INVENTION

An object of the present invention is to provide a control apparatus for controlling two hot-swappable IDE devices connected within a same computer system IDE channel, to allow hot-swapping of one of the devices without interrupting the server or idling the paired IDE device.

Another object of the present invention is to provide a method for controlling hot-swapping of two hot-swappable IDE devices connecting within a same IDE channel.

To accomplish the above-mentioned objects, the present invention provides a control apparatus adapted to control two hot-swappable IDE devices installed in one channel of a computer system. The control apparatus includes a power supply and corresponding power switches for affording electrical power to the IDE devices, an IDE controller, a first and second quick switches, an IDE connector electrically connected between the quick switches and the IDE controller, and a hot-swap controller communicating with the IDE controller through the IDE connector. The hot-swap controller controls the turning on and off of the quick switches, thereby disabling IDE bus signals from being sent to an IDE device which has been hot unplugged and enabling IDE bus signals to be sent to an IDE device which has been hot plugged. The hot-swap controller also controls the turning on and off of the power switches, thereby disconnecting power from an IDE device which has been hot unplugged, and connecting power to an IDE device which has been hot plugged.

Further objects and advantages of the present invention will become more apparent from a consideration of the drawings and the following detailed description.

### BRIEF DESCRIPTION OF THE DRAWINGS

FIG. 1 is a block diagram of a control apparatus for controlling two hot-swappable IDE devices connecting to a same IDE channel;

FIG. 2 is a flow diagram illustrating control steps of the control apparatus of FIG. 1 when one hot-swappable IDE device is hot unplugged; and

FIG. 3 is a flow diagram illustrating control steps of the control apparatus of FIG. 1 when one hot-swappable IDE device is hot plugged.

### DETAILED DESCRIPTION OF THE PREFERRED EMBODIMENT

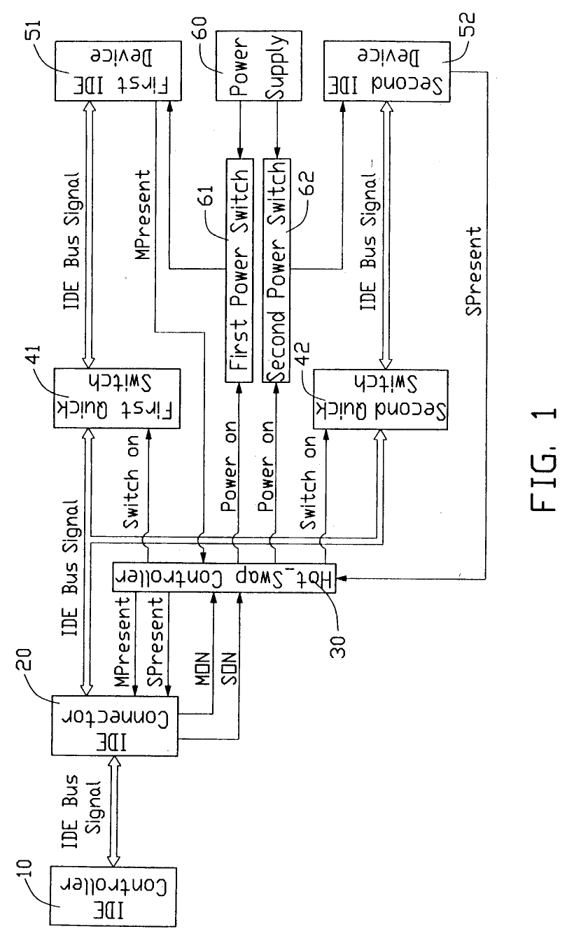

Referring to FIG. 1, a control apparatus according to one embodiment of the present invention includes an IDE controller 10, an IDE connector 20, a hot-swap controller 30, and a first and second quick switches 41, 42, for controlling a first and second IDE devices 51, 52 in a computer system (not shown). The IDE devices can be IDE memory devices, for instance, IDE_HDDs. Illustratively, the IDE devices 51, 52 will refer to IDE_HDDs in this embodiment. A power supply 60 in the computer system supplies electrical power for the IDE_HDDs 51, 52 through a first and second power switches 61, 62. In this embodiment all electrical elements are triggered by low level voltage, that is, they are actuated when a low voltage level signal (logic “0”) is applied at a terminal and are not actuated when a high voltage level signal (logic “1”) is applied at the terminal.

The IDE controller 10 sends IDE bus signals, including address signals, data signals, and control signals, to the IDE connector 20 through IDE cables (not shown), which are in turn relayed to the first and second quick switches 41, 42 respectively. The quick switches 41, 42 transmit/block IDE bus signals being sent to the IDE_HDDs 51, 52 when the quick switches 41, 42 are switched on/off. Both of the two IDE_HDDs 51, 52 are plugged into the computer system and are powered up and are running when they are in an operable condition. However, only one of the IDE_HDDs can be in working mode in the computer system at a time; the other is in standby mode. One of the quick switches 41, 42 corresponding to the IDE_HDD 51, 52 which is in standby mode is switched off. The first and second quick switches 41, 42 cannot be in an on state at the same time, and if one quick switch 41, 42 is switched on, the other one is in the off state.

If the first and second IDE_HDDs 51, 52 are both present in the computer system, a user will control which one will be accessed through control of the IDE controller 10. For instance, if the user determines that the first IDE_HDD 51 is to be accessed, the IDE controller 10 will send a control signal “MON=0” to the hot-swap controller 30 via the IDE connector 20. Then the hot-swap controller 30 will send a control signal of “PowerON=0” to the first power switch 61, which will cause the first power switch 61 to turn on, and the power from the power supply 60 will be connected to the first IDE_HDD 51. The hot-swap controller 30 will also send a control signal of “SwitchON=0” to the first quick switch 41, which will cause the first quick switch 41 to turn on, and therefore IDE bus signals sent by the IDE controller 10 will be input into the first IDE_HDD 51. Correspondingly, the IDE controller 10 will not send a control signal of “SON=0”, and therefore the hot-swap controller 30 will not send a control signal of “SwitchON=0” to the second quick switch 42, so the second quick switch 42 keep closed and IDE bus signals will not be transmitted through the second quick switch 42. Therefore, the second IDE_HDD 52 will be inaccessible. On the other hand, if the user wanted to access the second IDE_HDD 52, the IDE controller 10 would send a control signal of “SON=0”, which would cause the second quick switch 42 to turn on, and therefore IDE bus signals sent by the IDE controller 10 would be input into the second IDE_HDD 52. The first quick switch 41 would, in this case, be inaccessible.

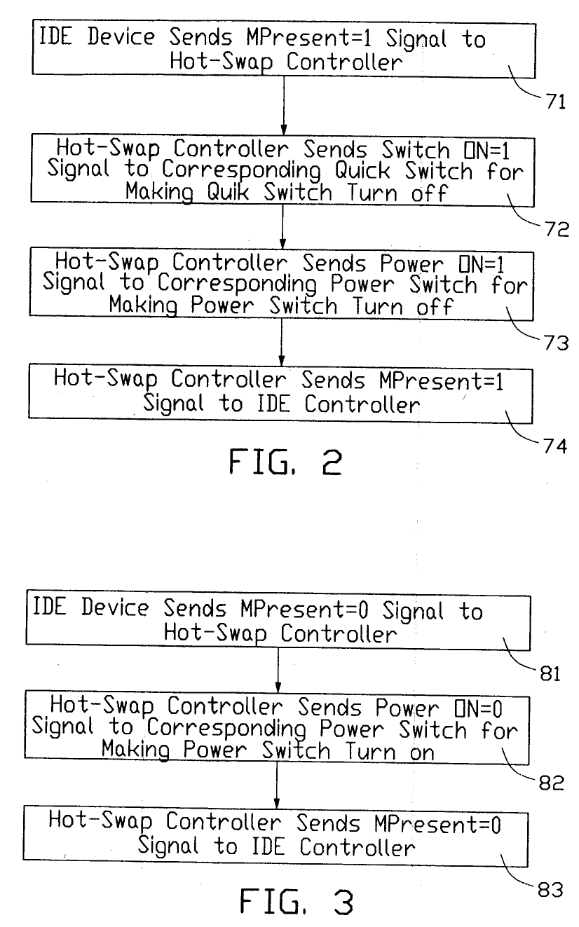

Referring to FIG. 2, a flow diagram shows the steps in the response of the control apparatus of FIG. 1 to a hot-swappable IDE device being hot unplugged. For instance, if the first IDE_HDD 51 is hot unplugged while in working mode, step 71 indicates that a signal of “MPresent=1” will be sent from the first IDE_HDD 51 to the hot-swap controller 30. Then the process will move to step 72, where the hot-swap controller 30 will send a control signal of “SwitchON=1” to the first quick switch 41, causing the first quick switch 41 to turn off so that IDE bus signals sent by the IDE controller 10 cannot transmit to the first IDE_HDD 51. Note that, at the same time, the hot-swap controller will send a control signal of “SwitchON=0” to the second quick switch 42 to allow IDE bus signals to transmit to the second IDE_HDD 52. Next, the process moves to step 73, where the hot-swap controller 30 sends a control signal of “PowerON=1” to the first power switch 61, causing the first power switch 61 to turn off so that power from the power supply 60 is cut off from the first IDE_HDD 51. Power remains connected, of course, to the second IDE_HDD 52. Finally, in step 74 the hot-swap controller 30 sends a signal of “MPresent=1” to the IDE controller 10 through the IDE connector 20, so that the IDE controller 10 will not send IDE bus signals to the first IDE_HDD 51. The hot-swap controller 30 also sends a signal of “SPresent=0” to the IDE controller 10 so that the IDE controller 10 will send IDE bus signals to the second IDE_HDD 52. The process of hot unplugging the second IDE_HDD 52 is similar.

The flow diagram in FIG. 3 shows the steps in the response of the control apparatus of FIG. 1 to a hot-swappable IDE device being hot plugged. For instance, if the first IDE_HDD 51 is hot plugged, the step 81 indicates that a signal of “MPresent=0” will be sent from the first IDE_HDD 51 to the hot-swap controller 30. Then the process will move to step 82, where the hot-swap controller 30 will send a control signal of “PowerON=0” to the first power switch 61, causing the first power switch 61 to turn on so that power from the power supply 60 will be connected to the first IDE_HDD 51. Next, the process will move to step 83, where the hot-swap controller 30 will send a signal of “MPresent=0” to the IDE controller 10 through the IDE connector 20, enabling the IDE controller 10 to start sending IDE bus signals for the first IDE_HDD 51. Note that, until the first quick switch 41 is closed, these IDE bus signals will not be received by the first IDE_HDD 51. At this time, the hot-swap controller 30 can accept a control signal of “MON=0” from the IDE controller 10. If the IDE controller 10 sends such a control signal, the hot-swap controller 30 will send a control signal of “SwitchON=0” to the first quick switch 41, causing the first quick switch 41 to turn on so that IDE bus signals sent by the IDE controller 10 can be transmitted to the first IDE_HDD 51. Note that if the IDE controller 10 does not send such a control signal, the second quick switch 42 will remain closed and the second IDE_HDD 52 will remain in working mode. The response to a hot plugging of the second IDE_HDD 52 is similar.

Note that hot unplugging and hot plugging of the IDE_HDDs can be completed without switching off the power supply 60. The present invention allows the user to use hot swapping in an IDE channel having two hot-swappable IDE devices. Use of the described control apparatus allows hot unplugging of the first IDE_HDD 51 with continued access to the second IDE_HDD 52. If the first IDE_HDD 51 is later hot plugged, the user can determine which of the two IDE_HDDs will be in working mode and, therefore, accessible. Therefore, the present invention allows full use of the IDE ports provided by the computer system.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A control apparatus adapted to control two hot-swappable IDE devices in one channel, comprising:
a power supply electrically connected to each IDE device through a corresponding power switch;
an IDE controller for sending IDE bus signals;
a first and second quick switches electrically connected to a corresponding IDE device for transmitting or blocking the IDE bus signals to the IDE devices;
an IDE connector electrically connected between the quick switches and the IDE controller; and
a hot-swap controller electrically connected with the IDE controller through the IDE connector, and with the first and second quick switches and the two power switches;
wherein, the hot-swap controller controls a quick switch to turn off when the corresponding IDE device has been hot unplugged, thereby blocking IDE bus signals transmitted thereto, and controls the quick switch to turn on when the corresponding IDE device has been hot plugged, thereby transmitting IDE bus signals transmitted thereto; and
wherein, the hot-swap controller controls the power switches to turn on or turn off so that power from the power supply will be cut off from an IDE device which has been hot unplugged, and power from the power supply will be connected to an IDE device which has been hot plugged.

2. The control apparatus as claimed in claim 1, wherein the IDE devices are IDE_HDDs, which are hard disk drives (HDDs) conforming to the Integrated Device Electronics (IDE) interface.

3. A control method for controlling two hot-swappable IDE devices, comprising:
when hot unplugging an IDE device:
having said IDE device send a signal to a hot-swap controller;
having the hot-swap controller send a control signal to a corresponding quick switch to cause said quick switch to turn off, whereby IDE bus signals sent by an IDE controller cannot input to said IDE device;
having the hot-swap controller send a control signal to a corresponding power switch to cause said power switch to turn off, whereby power from a power supply will be cut off from said IDE device;
having the hot-swap controller send a signal to the IDE controller through an IDE connector to prevent the IDE controller from sending further IDE bus signals to the IDE device; and
when hot plugging an IDE device:
having said IDE device send a signal to the hot-swap controller;
having the hot-swap controller send a control signal to the corresponding power switch to cause said power switch to turn on, whereby power output from the power supply can connect to said IDE device; and
having the hot-swap controller send a signal to the IDE controller through the IDE connector to cause the IDE controller to start sending IDE bus signals to the IDE device.

4. The control method as claimed in claim 3, further comprising at the end of the method for hot plugging an IDE device:
having the hot-swap controller accept a control signal from the IDE controller and then sending a control signal to the corresponding quick switch to cause said quick switch to turn on, whereby IDE bus signals sent by the IDE controller can be transmitted to said IDE device.

5. The control method as claimed in claim 3, wherein the IDE devices are IDE_HDDs which are hard disk drives (HDDs) conforming to the Integrated Device Electronics (IDE) interface.

6. The control method as claimed in claim 4, wherein the IDE devices are IDE_HDDs which are hard disk drives (HDDs) conforming to the Integrated Device Electronics (IDE) interface.

7. An electrical assembly for having first and second hot-swappable IDE (Integrated Device Electronics) devices sharing a same channel, comprising steps of:
a power supply electrically connected respectively to said first and second IDE devices through first and second power switches;
an IDE controller for sending IDE bus signals;
first and second quick switches electrically connected to the corresponding IDE devices, respectively, for transmitting or blocking the IDE bus signals to said corresponding IDE devices; and
a hot-swap controller electrically connected to the IDE controller, the first and second power switches, and the first and second quick switches; wherein
at most only one of said quick switches is turned on in all circumstances.

8. The assembly as claimed in claim 7, wherein when said first IDE device is unplugged, both the first power switch and the first quick switch are turned of, and said IDE controller stops sending IDE bus signals belong to said first IDE device.

9. The assembly as claimed in claim 7, where said hot-swap controller is electrically connected to said first IDE device and said second IDE device, respectively.
